(19) United States
(12) Patent Application Publication
(10) Pub. No.: US 2020/0321701 A1
(43) Pub. Date: Oct. 8, 2020

(54) Sleeved Dipole Antenna for Multi-Octave Broadside Radiation Pattern Control

(71) Applicant: Southwest Research Institute, San Antonio, TX (US)

(72) Inventors: Brandon L. Nance, Boerne, TX (US); Don E. Mahoney, San Antonio, TX (US); Thomas E Christian, JR., San Antonio, TX (US)

(21) Appl. No.: 16/374,098

(22) Filed: Apr. 3, 2019

(51) Int. Cl. H01Q 9/20; H01Q 9/28

(52) U.S. Cl. CPC H01Q 9/20; H01Q 9/28

(57) ABSTRACT

A method of maximizing the radiation pattern at broadside of a dipole antenna. The antenna is formed with a dipole wire having a sleeve centered along the length of the dipole wire. This sleeve is made from a conductive material and has a length relative to the dipole length that causes the dipole antenna to have an elevation gain pattern that maintains a peak at zero elevation over a much greater bandwidth than a conventional dipole.

### TECHNICAL FIELD OF THE INVENTION

This invention relates to antennas, and more particularly to improving the bandwidth of dipole antennas.

### BACKGROUND OF THE INVENTION

Dipole antennas are a class of antennas that produce a radiation pattern approximating that of an elementary electric dipole. A dipole antenna has two identical conductive elements such as metal wires or rods. The driving current from the transmitter is applied, or for receiving antennas the incoming signal is taken, between the two halves of the antenna. Each side of a feedline to the transmitter or receiver is connected to one of the conductors.

Most commonly, a dipole antenna has two conductors of equal length oriented end-to-end with the feedline connected between them. Dipoles are frequently used as resonant antennas. A dipole antenna will naturally resonate at a particular frequency. Using the antenna at its resonant frequency is advantageous in terms of feed point impedance (and thus standing wave ratio), so its length is determined by the intended wavelength (or frequency) of operation.

The most commonly used dipole antenna is a center-fed half-wave dipole which is just under a half-wavelength long. The radiation pattern of half-wave (or most other) dipoles is maximum perpendicular to the conductor, falling to zero in the axial direction, thus implementing an omnidirectional antenna in the horizontal plane if installed vertically, or a weakly directional antenna in the horizontal plane if installed horizontally.

Dipoles typically operate over a narrow frequency band around the frequency whose wavelength is approximately twice the length of the dipole. Various modifications to the dipole or its feed mechanism have been devised to improve the bandwidth over which it is useable. In active (transmitting) applications, most efforts at increasing bandwidth are directed to impedance matching, in order to improve power transfer from a source into free space. In passive (receiving) applications, a dipole can often be used over a much broader frequency range even when the impedance match is poor, so long as it is sensitive enough to pick up the intended signal.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates the current distribution for a dipole antenna at various electrical lengths.

FIG. 2 schematically illustrates a sleeved dipole antenna in accordance with the invention.

FIG. 3 illustrates the far field radiation patterns of the sleeved dipole antenna.

FIG. 4 illustrates simulation results of the sleeved dipole antenna compared to a conventional dipole antenna, showing bandwidth improvement.

FIG. 5 illustrates normalized measured and modeled elevation angle patterns of a 1.4 meter sleeved dipole antenna for a frequency of 450 MHz.

FIGS. 6 and 7 illustrate two example embodiments of the sleeved dipole antenna having a center feed point.

FIGS. 8 and 9 illustrate two example embodiments of the sleeved dipole antenna having an offset feed point.

### DETAILED DESCRIPTION OF THE INVENTION

The following invention is directed to a method to substantially increase the useable bandwidth for a dipole antenna. The method is useful for both receiving and transmitting antennas but may be particularly useful for receiving antennas. Two common applications of receiving dipole antennas are signal survey and radio direction finding but there are many other applications.

The method enables either an improvement in gain at lower frequencies, or a reduction in the overall number of sub-bands and antennas used to cover a given amount of spectrum in an antenna array. These bandwidth improvements use an approach distinguishable from impedance matching. As explained below, a conductive sleeve around the feedpoint beneficially modifies the antenna's radiation pattern.

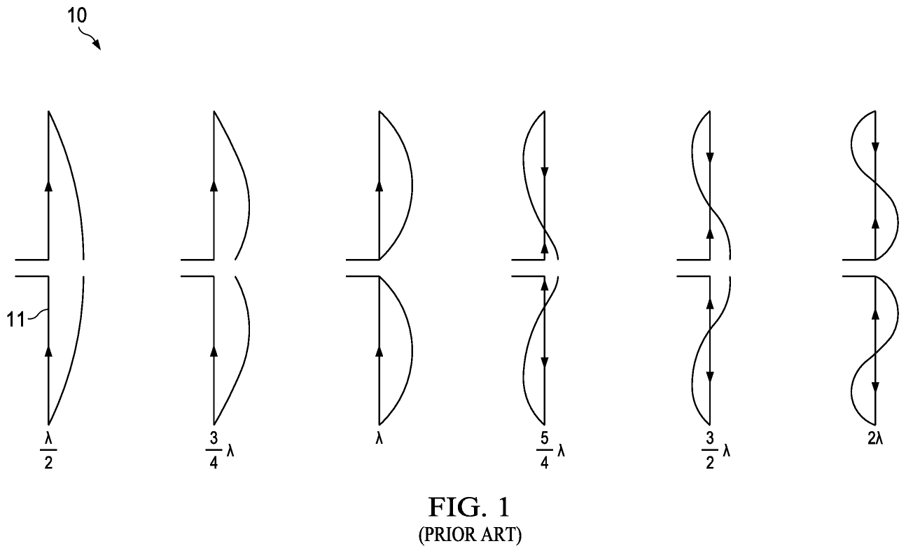

FIG. 1 illustrates the current distribution for a dipole antenna 10 at various electrical lengths. Various lengths, from a half wavelength to two wavelengths are illustrated. The dipole wire 21 is referred to herein as a “wire”, and in practice, consists of two parts (typically equal halves) separated by a feed point. The term “wire” as used herein is not limiting and can also include various types of conductive rods, poles, or other structures.

In extremely broadband dipole antenna applications, such as is the case with a receiving dipole antenna operating over multiple octaves of bandwidth, the limiting factor on the antenna's useable bandwidth is not its impedance match alone but also the shape of its radiation pattern. At frequencies much lower than the half-wavelength resonant frequency, the dipole is too small to receive efficiently (the impedance mismatch is too great). Therefore, the length of the dipole wire 11 determines the lower limit of the bandwidth.

At frequencies where the dipole wire 11 is approaching two wavelengths in length, the current distribution along the dipole is such that a null in the elevation angle is formed in its radiation pattern precisely where a maximum is required. This determines the upper limit of the bandwidth.

As shown in FIG. 1, the current along the length of the dipole wire is approximately sinusoidal. When the dipole is half a wavelength or shorter, a half-period sinusoidal current distribution produces maximum power at horizon. As the dipole increases in electrical length, the other half of the sinusoidal period begins to form until at two-wavelengths long, the currents along the dipole are equal and opposite. As a result, the antenna receives effectively no radiation in the horizontal plane (assuming vertical dipole orientation), i.e., at broadside or zero degrees elevation.

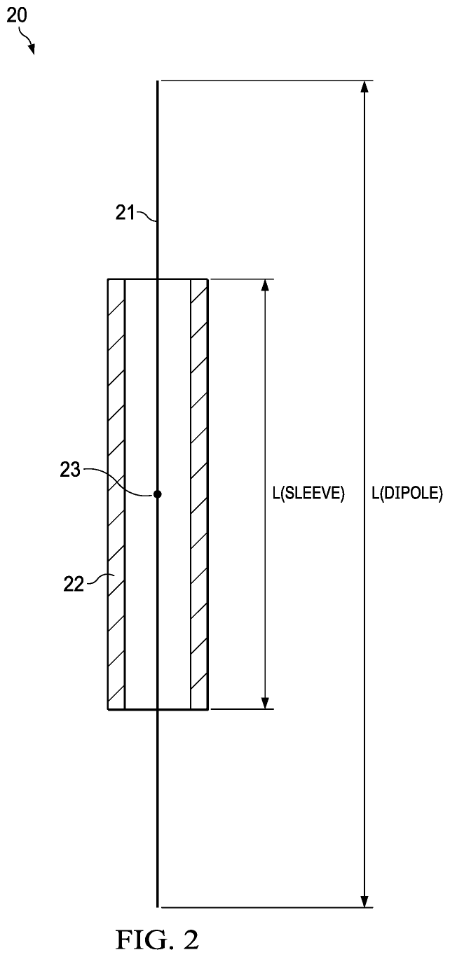

FIG. 2 schematically illustrates a “sleeved dipole antenna” 20 in accordance with the invention. As explained below, antenna 20 has an increased upper frequency limit for a given length. Equivalently, dipole antenna 20 can be longer for improved sensitivity in a given bandwidth.

The dipole wire 21 has a length, L. The dipole wire 21 may be any material appropriate for a dipole antenna, sometimes also referred to as a dipole rod, pole or conductor.

A conductive sleeve 22 is placed around the dipole wire 21. The dipole wire 21 runs through the middle of the sleeve 22, and the sleeve 22 is also centered lengthwise along the dipole wire 21. Where the feed point 23 is a center feed point, the sleeve 22 is centered around the feed point 23.

As explained below, the proper use of sleeve 22 modifies the radiating current distribution and mitigates the null in the radiation pattern appearing at zero degrees in the elevation plane. More specifically, sleeve 22 masks a portion of the current distribution on the dipole wire 21. This prevents the masked current from combining out of phase with the current nearer the dipole wire ends.

Furthermore, the current on the outside of the sleeve 22 tends to be equal and opposite that of the wire 21 inside sleeve 22. As a result, sleeve 22 acts as a secondary radiator, combining in phase with the exposed currents on either end of dipole wire 21.

At frequencies where the sleeved dipole antenna 20 is approaching 1.5-2.0 wavelengths in length (where a conventional wire dipole no longer radiates in the horizontal plane), the sleeved dipole antenna 20 acts as a series of three dipoles in a vertical array combining to form a strong peak in the horizontal plane.

Various dimensional parameters of antenna 20 can be varied to optimize antenna performance for a given application. The ratio of the sleeve length, L(sleeve), to the dipole length, L(dipole), can be varied. The diameters of the antenna wire 21 and sleeve 22 can also be varied.

With regard to the length of sleeve 22, it is expected that for many applications, the optimal length is approximately ⅓ of the length of the dipole wire 21. However, experimentation may show that other sleeve lengths are useful, depending on the antenna design and application.

Likewise, the radius of sleeve 22 can be modified to improve antenna performance as desired. A radius that is too small will adversely affect the impedance match (by almost shorting out the antenna). A radius that is too large compared to the highest wavelength can be problematic as well. For the example antenna of this description, the sleeve was a 2-inch diameter tube for a dipole antenna having a 30-500 MHz bandwidth. Typically, the sleeve diameter will be smaller than a quarter wavelength at the highest frequency of the antenna.

Furthermore, sleeve 22 can have an almost arbitrary cross section. Sleeve 22 can be implemented as a circular tube, but it could be a square tube, or one of many other profiles. Its diameter or width could be tapered as a function of the distance from the feed point to improve impedance match and bandwidth.

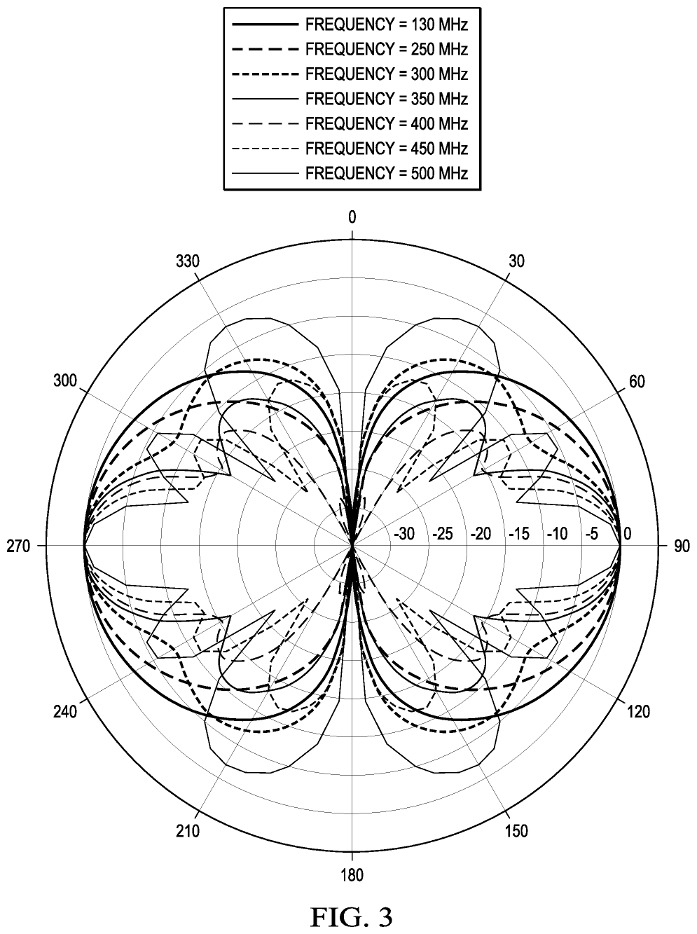

FIG. 3 illustrates an example of the far field radiation patterns in the E-plane (co-polarized electric field gain versus theta) of a sleeved dipole antenna 20. The horizontal axis (theta=90 or 270) is equivalent to zero elevation, where the gain is desired to be at a local maximum.

Electrical isolation between the sleeve 22 and the dipole wire 21 is maintained. The dipole wire 21 may be suspended within sleeve 22 in a variety of ways. Plastic or foam inserts, caps, and/or potting using nonconductive material can be used. Other techniques of supporting the sleeve 22 around the dipole wire 21 can also be devised.

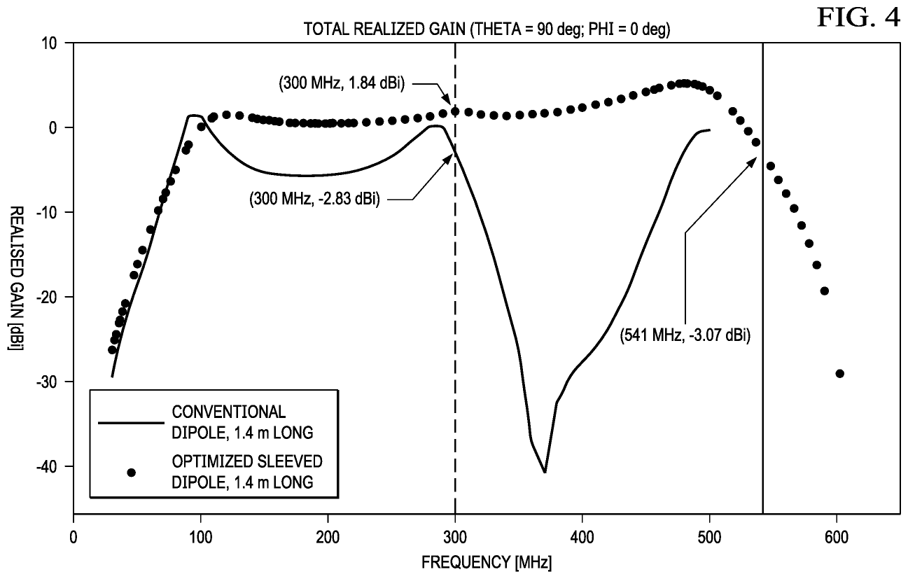

FIG. 4 illustrates simulation results of a sleeved dipole antenna 20 compared to a conventional dipole antenna, showing the bandwidth improvement. Both the sleeved dipole antenna and the conventional antenna were 1.4 meters in length.

These simulations show that the original useable bandwidth of a conventional dipole antenna of 30-300 MHz can be increased by more than 80% to 30-520 MHz. This enables use of a dipole antenna over nearly another octave of bandwidth.

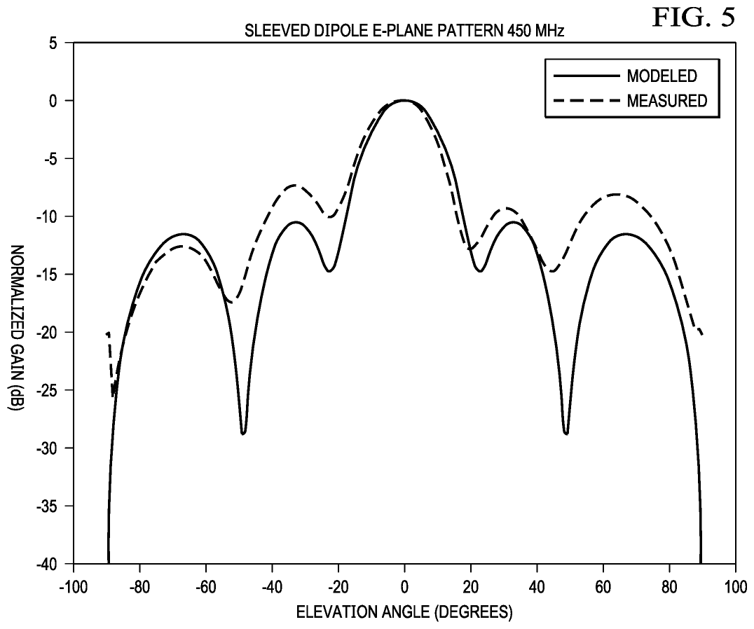

For the same example of a 1.4 meter sleeved dipole antenna, FIG. 5 illustrates normalized measured and modeled elevation angle patterns in decibels for a frequency of 450 MHz. The pattern shows a gain peak at 0 degrees (the center of the horizontal axis) is maintained as desired. This pattern is referred to herein as a “elevation gain pattern having a peak at zero degrees”. The radiation pattern is maximized at broadside. Similar patterns can be maintained up to 500 MHz and beyond.

A feature of masking sleeve 22 is that it is parasitic in nature. Sleeve 22 is not connected to the dipole wire 21, or to the dipole feed network, or to any other electrical elements of the dipole antenna 20. Also, the objective of sleeve 22 is to control or shape the radiation pattern over multi-octave bandwidths as compared to improving impedance match.

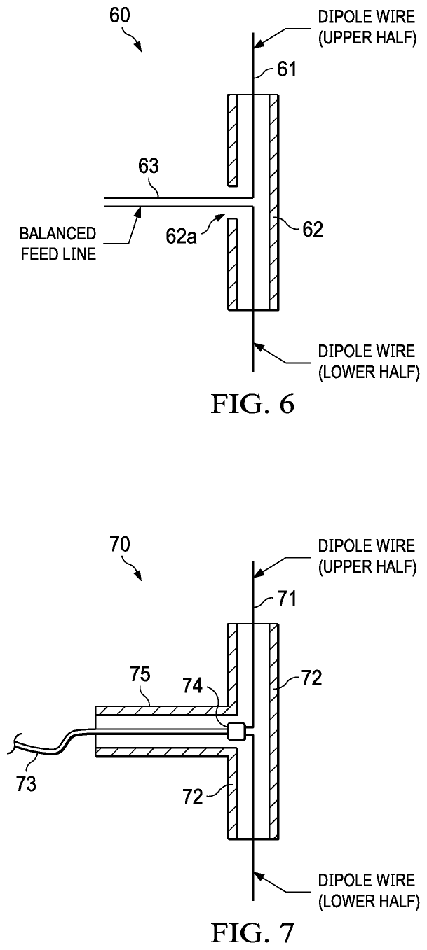

FIGS. 6 and 7 illustrate two embodiments of the sleeved antenna. There are a number of ways to feed the sleeved dipole, whether with a balanced transmission line feed or with an unbalanced transmission line feed and a balun, fed in the center or offset-fed. An offset feed is a common practice to modify the real part of the impedance of the dipole.

FIG. 6 illustrates a sleeved dipole antenna 60, whose dipole wire 61 has an upper half and lower half. The sleeve 62 is a hollow cylinder centered around the center point of the dipole wire 61. The feed line 63 is a balanced feed line at the center point of the dipole wire 61. A hole 62a in the sleeve 62 provides access for feed line 63.

FIG. 7 illustrates a sleeved dipole antenna 70, also having a center feed line 73. In this embodiment, halves of the dipole wire 71 connect to a balun 74 and coaxial cable 75. The feed line 73 is within a hollow and conductive boom 75 perpendicular to sleeve 72.

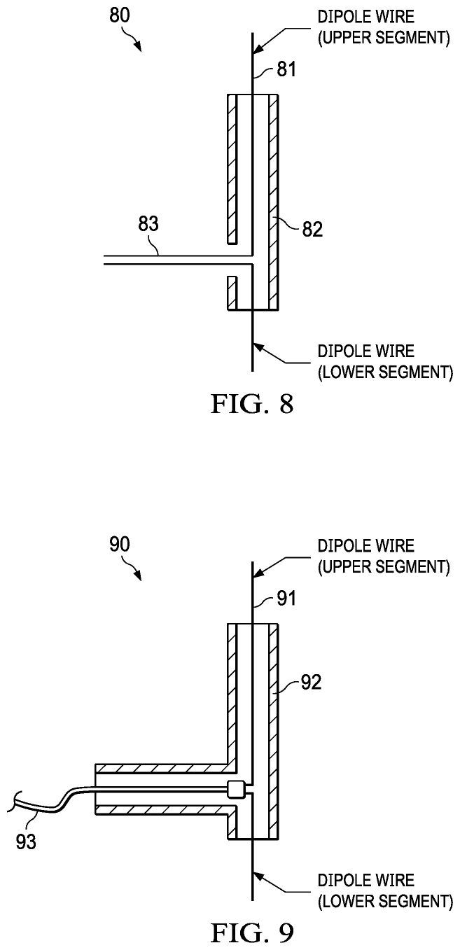

FIGS. 8 and 9 illustrates embodiments of sleeved dipole antennas 80 and 90, which are similar to those of FIGS. 6 and 7 but with offset feed lines. In both cases, the sleeve 82 and 92 is centered along the length of the dipole wire 81 and 82. The feed lines 83 and 93 are balanced in the case of antenna 80 and coaxial in the case of antenna 90.

In other embodiments, it may be possible to arrange more than one sleeve in series, but not connected to each other.

In sum, various embodiments of the sleeved dipole antenna are possible. Each embodiment uses a sleeve around the dipole wire to maintain a maximum in the radiation pattern at broadside (in the plane normal to the dipole) across an expanded frequency range.

What is claimed is:

1. A method of maximizing the radiation pattern at broadside of a dipole antenna, comprising:
forming the dipole with a dipole wire having a predetermined dipole length and a feed point that divides the dipole wire into two parts;
placing a sleeve around the dipole wire such that the sleeve is electrically isolated from all electrical elements of the dipole antenna;
wherein the sleeve is centered along the length of the dipole wire;
wherein the sleeve is made from a conductive material and has a length relative to the dipole length that causes the dipole antenna to have an elevation gain pattern that maintains a peak at zero elevation.

2. The method of claim 1, further comprising operating the dipole antenna as a receive-only antenna.

3. The method of claim 1, wherein the dipole wire has a center feed point.

4. The method of claim 1, wherein the dipole wire has an offset feed point.

5. The method of claim 1, wherein the sleeve has a length approximately one-third the length of the dipole.

6. The method of claim 1, wherein the sleeve is electrically isolated with insulation material between the sleeve and the dipole wire.

7. The method of claim 1, wherein the diameter of the sleeve is less than one-quarter wavelength at the maximum frequency of the antenna.

8. The method of claim 1, wherein the diameter of the sleeve is constant.

9. The method of claim 1, wherein the sleeve has a tapered diameter.

10. The method of claim 1, wherein the sleeve has a circular cross section.

11. A dipole antenna, comprising:
a dipole wire with a predetermined dipole length and a feed point;
a sleeve around the dipole wire, arranged such that the sleeve is electrically isolated from all electrical elements of the dipole antenna;
wherein the sleeve is centered along the dipole wire;
wherein the sleeve is made from a conductive material and has a length relative to the dipole length that causes the dipole antenna to have a horizontal gain pattern with a peak at zero elevation.

12. The method of claim 11, wherein the dipole wire has a center feed point.

13. The method of claim 11, wherein the dipole wire has an offset feed point.

14. The method of claim 11, wherein the sleeve has a length approximately one-third the length of the dipole.

15. The method of claim 11, wherein the sleeve is electrically isolated with insulation material between the sleeve and the dipole wire.

16. The method of claim 11, wherein the diameter of the sleeve is less than one-quarter wavelength at the maximum frequency of the antenna.

17. The method of claim 11, wherein the diameter of the sleeve is constant.

18. The method of claim 11, wherein the sleeve has a tapered diameter.

19. The method of claim 11, wherein the sleeve has a circular cross section.
